(19) United States
(12) Patent Application Publication
(10) Pub. No.: US 2024/0184872 A1
(43) Pub. Date: Jun. 6, 2024

(54) COMPUTER IMPLEMENTED CONFERENCING SYSTEM AND METHOD

(71) Applicant: Airmeet Inc., Walnut, CA (US)

(72) Inventors: Lalit Mangal, Noida (IN); Vinay Kumar Jaasti, Bengaluru (IN); Aurobindum Sengupta, Guwahati (IN); Mehtab Singh Gill, Amritsar (IN)

(21) Appl. No.: 18/172,343

(22) Filed: Feb. 22, 2023

(30) Foreign Application Priority Data
Dec. 5, 2022 (IN) 202211070138

(51) Int. Cl. G06F 21/35; G06F 3/0484

(52) U.S. Cl. CPC G06F 21/35; G06F 3/0484; H04L 65/403

(57) ABSTRACT

Embodiments disclosed include computer implemented video conferencing methods and systems that enable collaborative computing and remote control through secondary devices by authenticating a user via a first graphical user interface comprised in a primary device, and enabling authentication of a second graphical user interface through the authenticated first user interface. Additional systems and methods include, via the second authenticated graphical user interface, enabling control of the first graphical user interface and implementing a single or plurality of control commands via the second authenticated graphical user interface on the first graphical user interface.

### FIELD

Example embodiments relate to screen sharing systems, and more particularly to multi-tasking protocols in audio and video conferencing systems and methods between transmitting, receiving and collaborating devices.

### BACKGROUND

An increasing number of electronic devices today come equipped with cameras, displays, audio, and communication capabilities, and therefore are enabled to participate in multi-user video conference calls. During such video conference calls, voice or data connections are typically made between two or more communication devices such as laptops, tablet computers or/and mobile communication devices, whereby image data captured from cameras associated with the communication devices is transmitted between the devices. Additionally, image data is shared between devices using screen sharing applications and other such technology. In certain instances, a video conference call can be used for a collaborative computing session, such as an interactive conference where an organizer of the conference conducts visual demonstrations for other participants in the conference.

For example, an organizer of the video conference call can request to initiate a screen sharing session with a receiving device. During the screen sharing session, image data depicting the screen of the organizer's device is transmitted to a receiving device connected via the video conference call. Based on the transmitted image data, the receiving device can see the same user interface or a portion of the same user interface displayed on the organizer's device. Moreover, when the organizer performs actions on the user interface, the receiving device can view the performed actions based on updated image data.

However, performing some basic actions during the screen share can become challenging. For example, muting and unmuting a session is inconvenient especially if the user is on another tab or/and is sharing their screen. Further, co-browsing, real-time chats or/and questions and answers (QNA) during a screen share becomes difficult or impossible to monitor and participate in. The presenter of the screen share has no idea what is happening in the chats or/and QNA when they have shared their screen and are currently on another tab, until they come back to the video conference tab. Embodiments disclosed address these challenges, and more in the disclosed systems and methods.

### SUMMARY

Embodiments disclosed include a computer implemented video conferencing method comprising, authenticating a user via a first graphical user interface comprised in a first computing device. According to an embodiment, via the first graphical user interface, the computer implemented video-conferencing method includes enabling authentication of a second graphical user interface. In one embodiment, control of the first graphical user interface is activated in the second authenticated graphical user interface, upon authentication, enabling implementing a single or plurality of control commands via the second authenticated graphical user interface on and by the first graphical user interface. According to an embodiment the second graphical user interface is comprised in a second computing device. Alternatively, the second graphical user interface may be comprised in the first computing device.

According to an embodiment, the second authenticated graphical user interface mirrors a single or plurality of controls of the first graphical user interface, enabling the second graphical user interface to input and execute the single or plurality controls on behalf of the first user interface.

Embodiments disclosed include a computer automated video-conferencing system comprising a processing unit and a memory element having instructions encoded thereon. According to an embodiment, the encoded instructions when implemented by the processing unit cause the computer automated video-conferencing system to authenticate a user via a first graphical user interface comprised in a first computing device. According to an embodiment, via the first graphical user interface, the computer automated system is caused to enable authentication of a second graphical user interface. In one embodiment, control of the first graphical user interface is activated in the second authenticated graphical user interface, upon authentication, to enable control of the first graphical user interface to implement a single or plurality of control commands via the second authenticated graphical user interface on the first graphical user interface. According to an embodiment the second graphical user interface is comprised in a second computing device. Alternatively, the second graphical user interface may be comprised in the first computing device.

According to an embodiment of the computer automated system, the second authenticated graphical user interface is caused to mirror a single or plurality of controls of the first graphical user interface, enabling the second graphical user interface to input and execute the single or plurality controls on behalf of the first user interface.

According to an embodiment a computer implemented method comprises implementing multiple functions across multiple applications by enabling multiple input data streams simultaneously, from and to a corresponding multiple device primary graphical user interfaces. An embodiment includes sending and receiving data modification information via a network from and to the corresponding multiple device primary graphical user interfaces, wherein the multiple device primary graphical user interfaces are configured to accept multiple input data streams simultaneously. An embodiment includes enabling a first device primary graphical user interface to control the multiple device primary graphical user interfaces, and preferably replicating a modification in the first device primary graphical user interface in each of the multiple device primary graphical user interfaces. According to a preferred embodiment, the computer implemented method comprises distinguishing modified primary graphical user interface data from non-modified primary graphical user interface data to send and receive modified primary graphical user interface data without sending the non-modified primary graphical user interface data to said sending and receiving multiple primary graphical user interfaces. According to a preferred embodiment, each of the primary graphical user interfaces can enable and activate a corresponding secondary graphical user interface which comprises authentication of a secondary graphical user interface by the authenticated first primary graphical user interface. According to an embodiment, the computer implemented method enables initiating partial, complete or mutual control of the primary and secondary graphical user interfaces by each other. One embodiment comprises implementing control by the secondary graphical user interface for muting and un-muting audio, enabling and disabling video/camera, and initiating textual chats and messages by the secondary graphical user interface on behalf of the primary graphical user interface. An alternate embodiment of the method comprises enabling the secondary graphical user interface to mirror exactly the corresponding primary graphical user interface.

According to an embodiment, a computer automated system comprises a processing unit coupled to a memory element and having instructions encoded thereon, which instructions cause the computer automated system to implement multiple functions across multiple applications. Preferably, the computer automated system is configured to enable multiple input data streams simultaneously, from and to a corresponding multiple device primary graphical user interfaces. According to an embodiment, the computer automated system is further configured to send and receive data modification information via a network from and to the corresponding multiple device primary graphical user interfaces wherein the multiple device primary graphical user interfaces are configured to accept multiple input data streams simultaneously. According to one embodiment, the computer automated system is configured to enable a first device primary graphical user interface to control the multiple device primary graphical user interfaces, and replicate a modification in the first device primary graphical user interface in each of the multiple device primary graphical user interfaces. According to a preferred embodiment, the computer automated system is configured to distinguish modified primary graphical user interface data from non-modified primary graphical user interface data to send and receive modified primary graphical user interface data without sending the non-modified primary graphical user interface data to said sending and receiving multiple primary graphical user interfaces.

According to a preferred embodiment of the computer automated system, each of the primary graphical user interfaces can enable and activate a corresponding secondary graphical user interface which comprises authentication of a secondary graphical user interface by the authenticated first primary graphical user interface. According to an embodiment, the computer automated system is configured to enable initiating partial, complete or mutual control of the primary and secondary graphical user interfaces by each other. One embodiment comprises implementing control by the secondary graphical user interface for muting and un-muting audio, enabling and disabling video/camera, and initiating textual chats and messages by the secondary graphical user interface on behalf of the primary graphical user interface. An alternate embodiment of the computer automated system comprises enabling the secondary graphical user interface to mirror exactly the corresponding primary graphical user interface.

### BRIEF DESCRIPTION OF THE DRAWINGS

FIG. 1 illustrates the method according to an embodiment.

FIG. 2 illustrates the system according to an embodiment.

FIG. 3 illustrates a block diagram of the system according to an embodiment.

FIG. 4 illustrates a block diagram of the system according to an alternate embodiment.

FIG. 5 illustrates the method according to an alternate embodiment.

### DETAILED DESCRIPTION

Various aspects are described in connection with an illustrative implementation of collaborative computing in audio and video conferencing systems and methods disclosed herein. The various aspects are disclosed in the written specification including the drawings, and claims, and may be combined to form claims for a device, apparatus, system, method of manufacture and/or use in any way, consistent with the teachings herein, without limitation. In an online video conference, performing some basic actions such as muting/unmuting or leaving a session is sometimes a little inconvenient, especially if the user is on another tab or if sharing their screen. They have no idea what is happening in chats or QNA if they have shared their screen and are currently on another tab until they come back to the video conference tab.

Embodiments disclosed enable users to control audio/video settings, read and reply to chat messages remotely from another secondary device like a mobile phone in an online video conference on a primary device.

According to one embodiment, a user A (say) opens a “magic” link from another device (for example, a mobile phone) via scanning a QR code unique to the user from the active video conference system. Alternatively, the user A can access a link in order to mirror the active video conferencing system on their mobile device.

According to an embodiment, opening this “magic” link creates a pseudo-user A′ (say) wherein the pseudo-user device will be auto authenticated into the video conference system

This Pseudo user A′ is presented with controls like Audio/Video, Chat messages, Leave Conference options on this secondary device. Other variations and modifications are possible, and in some instances even desirable, as would be apparent to a person having ordinary skill in the art.

According to one embodiment, any action (for example, muting audio) by this pseudo user A′ is communicated to the primary user A in active video conference via pub-sub mode of communication and these actions will be executed as if those are done by the primary user (A). Other users (B, C . . . ) in the video conference are not aware of pseudo user's (A′) presence and they see the results of these actions only (for example, A's audio is muted).

Embodiments disclosed include methods and systems for authenticating a user via a first graphical user interface. The disclosed methods and systems enable via the first user interface, authentication of a second graphical user interface, wherein the second graphical user interface mirrors a single or plurality of controls of the first graphical user interface, and further enable the second graphical user interface to input and execute the single or plurality controls on behalf of the first user interface.

Embodiments disclosed include a computer implemented video conferencing method comprising authenticating a user via a first graphical user interface comprised in a first computing device. According to an embodiment, via the first graphical user interface, the computer implemented video-conferencing method includes enabling authentication of a second graphical user interface. In one embodiment, control of the first graphical user interface is activated in the second authenticated graphical user interface, upon authentication, enabling implementing a single or plurality of control commands via the second authenticated graphical user interface on the first graphical user interface. According to an embodiment the second graphical user interface is comprised in a second computing device. Alternatively, the second graphical user interface may be comprised in the first computing device.

According to an embodiment, the second authenticated graphical user interface mirrors a single or plurality of controls of the first graphical user interface, enabling the second graphical user interface to input and execute the single or plurality controls on behalf of the first user interface.

According to another embodiment, the second authenticated graphical user interface is reconfigurable in its' operational role to control the first graphical user interface. Control can be handed over to the second authenticated graphical user interface, partially or completely. Optionally, control can be jointly managed wherein the first and second interfaces are configured to interchangeably control each other.

According to an embodiment of the computer implemented video-conferencing method, enabling control of the first graphical user interface via the second authenticated graphical user interface comprises enabling control of at least one of an audio muting and un-muting facility, a video enabling and disabling facility, a textual chat facility and a screen sharing facility.

In an embodiment of the computer implemented method, enabling authentication of the second graphical user interface comprises enabling authentication via a short range communication means comprised in the first and second graphical user interfaces respectively. An embodiment of the computer implemented method comprises a Quick Response or QR code generating means in the first graphical user interface and a QR code scanning means in the second graphical user interface. Alternate embodiments comprise at least one of a Near Field Communication system, an infrared communication system, a wireless router authentication and communication system, and a radio frequency communication system. However, other variations are also possible, likely and in some instances even desirable, as would be apparent to a person having ordinary skill in the art. Yet another alternate embodiment is executed by generating an active link, herein referred to as “magic link” by the primary device and sending the “magic link” to the secondary device. Yet another alternate embodiment is executed by pairing the primary graphical user interface with the secondary graphical user interface wirelessly or otherwise.

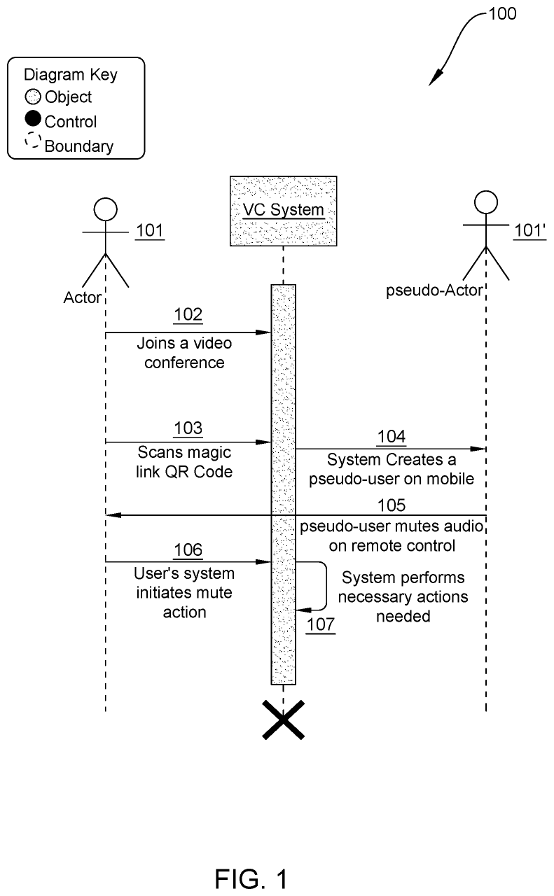

FIG. 1 illustrates the method in the form of a sequence diagram according to an embodiment. The method 100 begins with Actor (user) 101 joining a videoconference in step 102. The first graphical user interface streams a “magic” link QR code 103, which when scanned by a mobile device creates a pseudo-user 101′ on the mobile device. The pseudo-user device can now control the first graphical user interface of user 101, to, for example mute audio in step 105 through the mobile device. The first graphical user interface is caused to respond and initiate the mute action 106 on the first graphical user interface. The system is caused to perform necessary actions as needed in step 107.

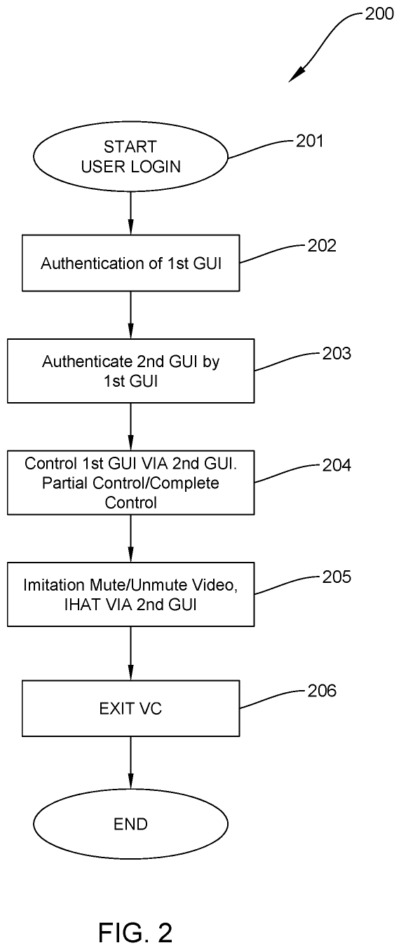

FIG. 2 illustrates a flow diagram according to an embodiment. The method starts at step 201 when a user logs in. Step 202 comprises authentication of the user's first graphical user interface. Step 203 includes authentication of a second graphical user interface by the authenticated first user interface. Step 204 enables initiating partial, complete or mutual control of the first and second user interfaces by each other. Step 205 comprises implementing control by the second graphical user interface for muting and un-muting audio, enabling and disabling video/camera, and initiating textual chats and messages by the second user interface on behalf of the first user interface. Step 206 enables exiting the videoconference by the first or second authenticated graphical user interface.

According to an embodiment a computer implemented method comprises implementing multiple functions across multiple applications by enabling multiple input data streams simultaneously, from and to a corresponding multiple device primary graphical user interfaces. An embodiment includes sending and receiving data modification information via a network from and to the corresponding multiple device primary graphical user interfaces, wherein the multiple device primary graphical user interfaces are configured to accept multiple input data streams simultaneously. An embodiment includes enabling a first device primary graphical user interface to control the multiple device primary graphical user interfaces, and preferably replicating a modification in the first device primary graphical user interface in each of the multiple device primary graphical user interfaces. According to a preferred embodiment, the computer implemented method comprises distinguishing modified primary graphical user interface data from non-modified primary graphical user interface data to send and receive modified primary graphical user interface data without sending the non-modified primary graphical user interface data to said sending and receiving multiple primary graphical user interfaces. According to a preferred embodiment, each of the primary graphical user interfaces can enable and activate a corresponding secondary graphical user interface which comprises authentication of a secondary graphical user interface by the authenticated first primary graphical user interface. According to an embodiment, the computer implemented method enables initiating partial, complete or mutual control of the primary and secondary graphical user interfaces by each other. One embodiment comprises implementing control by the secondary graphical user interface for muting and un-muting audio, enabling and disabling video/camera, and initiating textual chats and messages by the secondary graphical user interface on behalf of the primary graphical user interface. An alternate embodiment of the method comprises enabling the secondary graphical user interface to mirror exactly the corresponding primary graphical user interface.

According to an embodiment, a computer automated system comprises a processing unit coupled to a memory element and having instructions encoded thereon, which instructions cause the computer automated system to implement multiple functions across multiple applications. Preferably, the computer automated system is configured to enable multiple input data streams simultaneously, from and to a corresponding multiple device primary graphical user interfaces. According to an embodiment, the computer automated system is further configured to send and receive data modification information via a network from and to the corresponding multiple device primary graphical user interfaces wherein the multiple device primary graphical user interfaces are configured to accept multiple input data streams simultaneously. According to one embodiment, the computer automated system is configured to enable a first device primary graphical user interface to control the multiple device primary graphical user interfaces, and replicate a modification in the first device primary graphical user interface in each of the multiple device primary graphical user interfaces. According to a preferred embodiment, the computer automated system is configured to distinguish modified primary graphical user interface data from non-modified primary graphical user interface data to send and receive modified primary graphical user interface data without sending the non-modified primary graphical user interface data to said sending and receiving multiple primary graphical user interfaces.

According to a preferred embodiment of the computer automated system, each of the primary graphical user interfaces can enable and activate a corresponding secondary graphical user interface which comprises authentication of a secondary graphical user interface by the authenticated first primary graphical user interface. According to an embodiment, the computer automated system is configured to enable initiating partial, complete or mutual control of the primary and secondary graphical user interfaces by each other. One embodiment comprises implementing control by the secondary graphical user interface for muting and un-muting audio, enabling and disabling video/camera, and initiating textual chats and messages by the secondary graphical user interface on behalf of the primary graphical user interface. An alternate embodiment of the computer automated system comprises enabling the secondary graphical user interface to mirror exactly the corresponding primary graphical user interface.

Embodiments disclosed include a computer automated video-conferencing system comprising a processing unit and a memory element having instructions encoded thereon. According to an embodiment, the encoded instructions when implemented by the processing unit cause the computer automated video-conferencing system to authenticate a user via a first graphical user interface comprised in a first computing device. According to an embodiment, via the first graphical user interface, the computer automated system is caused to enable authentication of a second graphical user interface. In one embodiment, control of the first graphical user interface is activated in the second authenticated graphical user interface, upon authentication, to enable control of the first graphical user interface to implement a single or plurality of control commands via the second authenticated graphical user interface on the first graphical user interface. According to an embodiment the second graphical user interface is comprised in a second computing device. Alternatively, the second graphical user interface may be comprised in the first computing device.

According to an embodiment of the computer automated system, the second authenticated graphical user interface is caused to mirror a single or plurality of controls of the first graphical user interface, enabling the second graphical user interface to input and execute the single or plurality controls on behalf of the first user interface.

According to an embodiment of the computer automated video-conferencing system, the computer automated video-conferencing system is further caused to, in enabling control of the first graphical user interface via the second authenticated graphical user interface, enabling control of at least one of an audio muting and un-muting facility, a video enabling and disabling facility, a textual chat facility and a screen sharing facility.

In one embodiment of the computer automated video-conferencing system in enabling authentication of the second graphical user interface, the authentication step is implemented via a short range communication system comprised in the first and second graphical user interfaces respectively. Preferably, the short range communication system comprises a QR code generating means in the first graphical user interface and a QR code scanning means in the second graphical user interface.

Alternatively, the short range communication system comprises at least one of a near field communication (NFC) system, an infrared communication system, a wireless router authentication and communication system, and a radio frequency communication system.

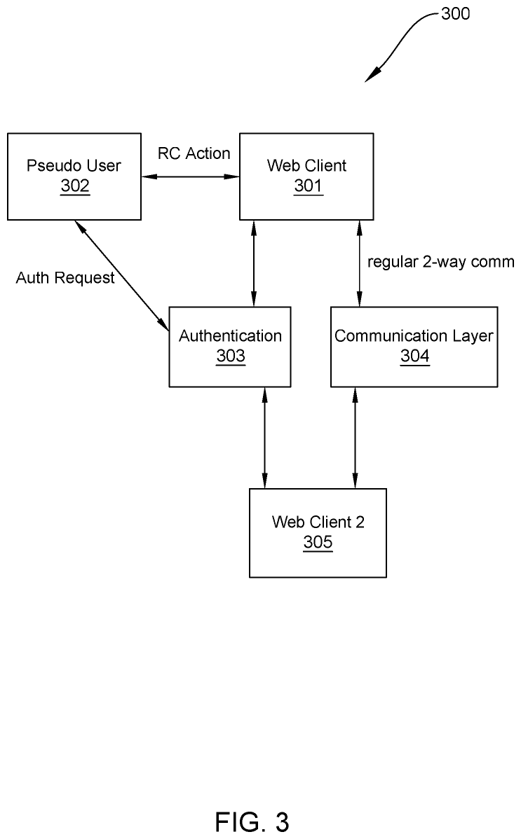

FIG. 3 illustrates a block diagram of the system 300 according to an embodiment. Web client 301 enables bi-directional communication with pseudo-user 302 after authentication by an authentication engine subsequent to an authentication request. The authentication engine is embedded in web client's 1 and 2, and enabled by an embedded communications layer 304 configured for bi-directional communication with web clients1 301 and web client 305 respectively.

According to an embodiment, Video Conference clients (301 and 305) authenticate with backend system (303) to join a video call. Communication Layer (304) in the system manages a video call after authenticating the clients. In one embodiment, the end user device can initiate a pseudo-user secondary device (302) by scanning a QR code with the secondary device on client (301) wherein the pseudo-user (302) authenticates themself with the system (303) to join the ongoing conference call. Preferably, the end user's actions on 302 are relayed to web-client (301).

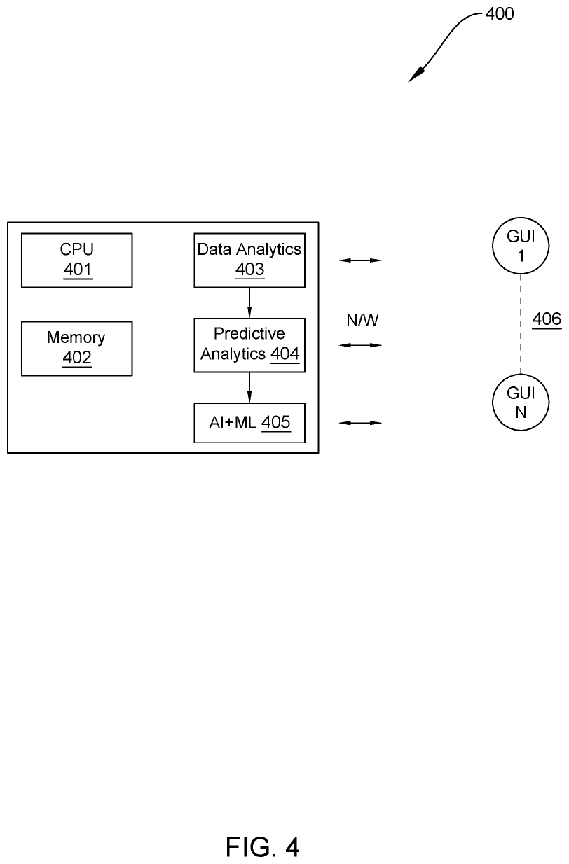

FIG. 4 illustrates a block diagram of the system according to an alternate embodiment. According to an embodiment, the computer automated video-conferencing system comprises a processing unit 401 and a memory element 402 having instructions encoded thereon. A preferred embodiment includes a Data Analytics engine 403 operatively coupled to a Predictive Analytics engine 404, which in turn is coupled to an Artificial Intelligence and Machine Learning engine 405. The computer automated video-conferencing system further comprises a plurality of graphical user interfaces 406 enabled to collaborate, communicate and synchronize with each other. The Data Analytics engine aggregates device behavior data, and based on the aggregated device behavior data, the predictive analytics engine is configured to optimize data flow. Preferably, the Artificial Intelligence and Machine Learning engine, based on the predictive analytics, can in real-time, configure and reconfigure the system to optimize device and user experience.

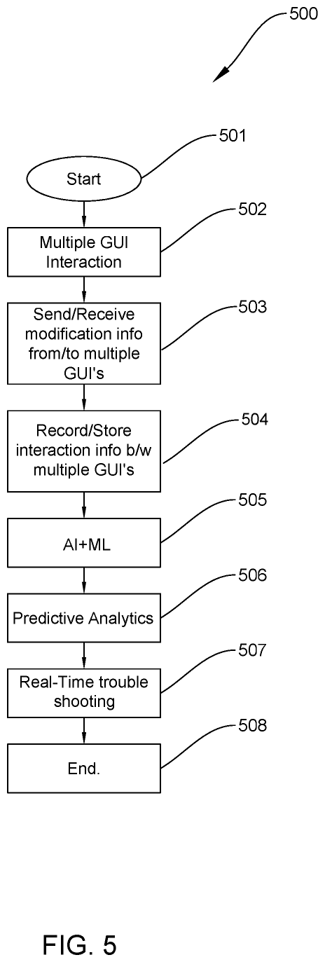

FIG. 5 illustrates the method according to one embodiment. Step 501 entails multiple user login and authentication. Step 502 enables multiple user interactions through corresponding multiple user interfaces including pseudo-user interfaces. Step 503 enables sending and receiving data modification information from and to multiple graphical user interfaces. Step 504 entails recording and storing the interactions between the multiple graphical user interfaces. Step 505 is an Artificial Intelligence (AI) based Machine Learning (ML) step that enables predictive analytics (step 506) and allows for real-time monitoring and trouble shooting (step 507). And step 508 ends the user interaction.

Embodiments disclosed include a wireless communication device comprising a processing unit, a graphical user interface, a memory element coupled to the processing unit and having encoded instructions thereon. According to an embodiment, the encoded instructions cause the processing unit to authenticate the graphical user interface via another primary graphical user interface comprised in a computer automated system. Based on the authentication, the wireless communication device is caused to generate a complete or partial mirror screen of the primary graphical user interface in the computer automated system. Preferably, generated mirror screen is enabled to receive an input or inputs for a single or plurality of control and communication commands on behalf of the primary graphical user interface in the computer automated system. According to an embodiment, the single or plurality of control and communication commands are comprised in a conferencing facility. According to an embodiment, control of the primary graphical user interface via the graphical user interface comprised in the wireless communication device comprises enabling control of at least one of an audio muting and un-muting facility, a video enabling and disabling facility, a textual chat facility and a screen sharing facility in the primary graphical user interface.

Embodiments disclosed include, in a wireless communication device comprising a graphical user interface, a method comprising, authenticating the graphical user interface to a primary graphical user interface comprised in a computer automated system. According to an embodiment, the method includes generating a complete or partial mirror screen of the primary graphical user interface in the computer automated system on the graphical user interface comprised in the wireless communication device. A preferred embodiment of the method further comprises enabling input of a single or plurality of control and communication commands on behalf of the primary graphical user interface comprised in the computer automated system. According to one embodiment, the single or plurality of control and communication commands are comprised in a conferencing facility. According to an embodiment, the method further comprises controlling the primary graphical user interface via the graphical user interface comprised in the wireless communication device by enabling control of at least one of an audio muting and un-muting facility, a video enabling and disabling facility, a textual chat facility and a screen sharing facility.

Embodiments disclosed enable performing basic and advanced actions including muting/unmuting or leaving a session in a videoconference seamlessly, even when the user is on another tab or is multi-tasking or/and screensharing. Embodiments disclosed enable the user to fully participate, engage, and collaborate even while having shared their screen and while they're on another tab on the primary graphical user interface. Embodiments disclosed enable users to control audio/video settings, read and reply to chat messages, by enabling another secondary device like a mobile phone, a tablet, or any other communication device in an online video conference on a primary device to move across tabs without the movement on the secondary device affecting the user's position on the primary device.

Since various possible embodiments might be made of the above invention, and since various changes might be made in the embodiments above set forth, it is to be understood that all matter herein described or shown in the accompanying drawings is to be interpreted as illustrative and not to be considered in a limiting sense. Thus it will be understood by those skilled in the art of systems and methods of collaborative computing, communication, audio and video conferencing, and screensharing, that although the preferred and alternate embodiments have been shown and described in accordance with the Patent Statutes, the invention is not limited thereto or thereby.

The figures illustrate the architecture, functionality, and operation of possible implementations of systems, methods and computer program products according to various embodiments of the present invention. It should also be noted that, in some alternative implementations, the functions noted/illustrated may occur out of the order noted in the figures. For example, two blocks shown in succession may, in fact, be executed concurrently, or the blocks may sometimes be executed in the reverse order, depending upon the functionality involved.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising.” when used in this specification, specify the presence of stated features, integers, steps, operations, elements, and/or components, but do not preclude the presence or addition of one or more other features, integers, steps, operations, elements, components, and/or groups thereof.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-accessible format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

The present invention and some of its advantages have been described in detail for some embodiments. It should be understood that although the system and process is described with reference to systems and methods of collaborative computing, communication, audio and video conferencing, and screensharing the system and method is highly reconfigurable, and may be used in other systems as well. Portions of the embodiment may be used to support other types of data communications, transfer, storage, surveillance, and other systems. Modifications of the embodiments may be used in mobile phone applications, pairing, smart watches, and other wireless electronic communication devices and graphical user interfaces. It should also be understood that various changes, substitutions and alterations can be made herein without departing from the spirit and scope of the invention as defined by the appended claims. An embodiment of the invention may achieve multiple objectives, but not every embodiment falling within the scope of the attached claims will achieve every objective. Moreover, the scope of the present application is not intended to be limited to the particular embodiments of the process, machine, manufacture, composition of matter, means, methods and steps described in the specification. A person having ordinary skill in the art will readily appreciate from the disclosure of the present invention that processes, machines, manufacture, compositions of matter, means, methods, or steps, presently existing or later to be developed are equivalent to, and fall within the scope of, what is claimed. Accordingly, the appended claims are intended to include within their scope such processes, machines, manufacture, compositions of matter, means, methods, or steps.

We claim:

1. A computer implemented video conferencing method comprising:
authenticating a user via a first graphical user interface;
via the first graphical user interface, enabling authentication of a second graphical user interface;
via the second authenticated graphical user interface, enabling control of the first graphical user interface;
implementing a single or plurality of control commands via the second authenticated graphical user interface on the first graphical user interface.

2. The computer implemented video-conferencing method of claim 1 wherein in enabling control of the first graphical user interface by the second graphical user interface, the control of the first graphical interface is at least one of partial, complete and mutual.

3. The computer implemented video-conferencing method of claim 1 wherein enabling control of the first graphical user interface via the second authenticated graphical user interface comprises enabling control of at least one of an audio muting and un-muting facility, a video enabling and disabling facility, a textual chat facility and a screen sharing facility.

4. The method as claimed in claim 1, wherein enabling control of the first graphical user interface via the second graphical user interface comprises:
generating a link by the first authenticated user interface;
sending the generated link by the first authenticated user interface to the second user interface; and
authenticating the second user interface via the sent generated link.

5. The computer implemented method of claim 1 wherein enabling authentication of the second graphical user interface comprises enabling authentication via a short range communication system comprised in the first and second graphical user interfaces respectively.

6. The computer implemented method of claim 5 wherein the short range communication system enables the first graphical user interface to generate a Quick Response (QR) and the second graphical user interface to scan the generated QR code.

7. The computer implemented method of claim 5 wherein the short range communication system comprises at least one of a Near Field Communication system, an infrared communication system, a wireless router authentication system, and a radio frequency communication system.

8. The computer implemented method of claim 5 wherein the short range communication system is configured to enable the first graphical user interface and the second graphical user interface to transmit and receive multiple input data streams simultaneously to and from a plurality of transmitting and receiving devices.

9. The computer implemented method of claim 5, wherein the short-range communication is configured to enable the first graphical user interface and the second graphical user interface to transmit and receive data modification information simultaneously to and from a plurality of transmitting and receiving devices.

10. A computer automated video-conferencing system comprising:
a processing unit;
a memory element having instructions encoded thereon, which instructions when implemented by the memory element cause the processing unit to:
authenticate a user via a first graphical user interface;
via the first graphical user interface, enable authentication of a second graphical user interface;
via the second authenticated graphical user interface, enable control of the first graphical user interface;
implement a single or plurality of control commands via the second authenticated graphical user interface on the first graphical user interface.

11. The computer automated video-conferencing system of claim 10 wherein in enabling control of the first graphical user interface by the second graphical user interface, the control of the first graphical interface is at least one of partial, complete and mutual.

12. The computer automated video-conferencing system of claim 10 wherein the processing unit is further caused to:
in enabling control of the first graphical user interface via the second authenticated graphical user interface, enabling control of at least one of an audio muting and un-muting facility, a video enabling and disabling facility, a textual chat facility and a screen sharing facility.

13. The computer automated video-conferencing system of claim 10, wherein enabling control of the first graphical user interface via the second graphical user interface comprises:
generating a link by the first authenticated user interface;
sending the generated link by the first authenticated user interface to the second user interface; and
authenticating the second user interface via the sent generated link.

14. The computer automated video-conferencing system of claim 10 wherein the computer automated video-conferencing system is further caused to:
in enabling authentication of the second graphical user interface, enable authentication via a short range communication system comprised in the first and second graphical user interfaces respectively.

15. The computer automated video-conferencing system of claim 14 wherein the computer automated video-conferencing system is further caused to:
generate a Quick Response (QR) code via the first graphical user interface; and
enable scanning of the QR code via the second graphical user interface.

16. The computer automated video-conferencing system of claim 14 wherein the short range communication system comprises at least one of a Near-Field communication (NFC) system, an infrared communication system, a wireless router authentication system, and a radio frequency communication system.

17. The computer automated video-conferencing system of claim 14, wherein the short-range communication is configured to enable the first graphical user interface and the second graphical user interface to transmit and receive multiple input data streams simultaneously to and from a plurality of transmitting and receiving devices.

18. The computer automated video-conferencing system of claim 14, wherein the short-range communication system is configured to enable the first graphical user interface and the second graphical user interface to transmit and receive data modification information simultaneously to and from a plurality of transmitting and receiving devices.

19. The computer automated video-conferencing system of claim 10, wherein the first graphical user interface is configured to transmit and receive modified graphical user interface data without transmitting non-modified graphical user interface data after distinguishing the modified graphical user interface data from the non-modified graphical user interface data; and wherein the second graphical user interface is configured to transmit the modified graphical user interface data on behalf of the first graphical user interface.

20. A wireless communication device comprising: a processing unit;
a graphical user interface;
a memory element coupled to the processing unit and having encoded instructions thereon, which instructions cause the processing unit to:
authenticate the graphical user interface to a primary graphical user interface comprised in a computer automated system;
generate a complete or partial mirror screen of the primary graphical user interface comprised in the computer automated system;
input a single or plurality of control and communication commands on behalf of the primary graphical user interface in the computer automated system; and
wherein the single or plurality of control and communication commands are comprised in a conferencing facility.

21. The wireless communication device of claim 20 wherein control of the primary graphical user interface via the graphical user interface comprises enabling control of at least one of an audio muting and un-muting facility, a video enabling and disabling facility, a textual chat facility and a screen sharing facility.

22. In a wireless communication device comprising a graphical user interface, a method comprising:
authenticating the graphical user interface to a primary graphical user interface comprised in a computer automated system;
generating a complete or partial mirror screen of the primary graphical user interface comprised in the computer automated system;
enabling input of a single or plurality of control and communication commands on behalf of the primary graphical user interface in the computer automated system; and
wherein the single or plurality of control and communication commands are comprised in a conferencing facility.

23. The method of claim 23 further comprising controlling the primary graphical user interface via the graphical user interface by enabling control of at least one of an audio muting and un-muting facility, a video enabling and disabling facility, a textual chat facility and a screen sharing facility.
